(19) United States
(12) Patent Application Publication
(10) Pub. No.: US 2007/0144444 A1
(43) Pub. Date: Jun. 28, 2007

(54) PET BED

(76) Inventor: Michele M. Hedges, Houston, TX (US)

Correspondence Address: WONG, CABELLO, LUTSCH, RUTHERFORD & BRUCCULERI,;L.L.P., 20333 SH 249, SUITE 600, HOUSTON, TX, 77070, US

(21) Appl. No.: 11/306,433

(22) Filed: Dec. 28, 2005

(51) Int. Cl. A01K 29/00

(52) U.S. Cl. 119/28.5

(57) ABSTRACT

A pet bed and method of making the pet bed are disclosed. The pet bed has an elongated tubular structure having a filling material. The tubular structure is formed into a spiral pattern that has a concavity or is flat. In one embodiment, the tubular structure can be made by attaching a plurality of tube socks closed end-to-open end. The closed ends form a plurality of baffles that separate portions of filling material within the tubular structure.

### FIELD OF THE DISCLOSURE

The subject matter of the present disclosure relates to an animal bed, and more particularly to a pet bed that has baffled sections containing stuffing.

### BACKGROUND OF THE DISCLOSURE

Different types of prior art pet beds are available on the market. In one example, the prior art pet beds are simply pillows having a body filled with fiberfill and having a removable cover. Although the removable cover may be washable, the fiberfill body may not be washable. After repeated use, the fiberfill will typically shift and clump together in the body making the bed uncomfortable and unable to provide support for the pet as intended. If the pet tears the cover, all of the filling can be pulled out of the bed ruining the bed. In another example, prior art pet beds are made with a foam base that may have a washable cover. Typically, the foam base is not washable so that it retains dirt and odors. The foam base can be convoluted for comfort and support, but the foam typically looses its resilience, deteriorates, and becomes brittle over time. Furthermore, if a pet rips through the removable cover, the pet is likely to rip up the foam base very easily.

As a pet owner will appreciate, pets like to burrow and prefer beds that have some type of bolstering. Some prior art pet beds have bolsters that are made with a rigid frame. Other prior art pet beds have a separate bolster that surrounds a base of the bed and has a pillow that fits within the bolster for comfort. There are also couches for pets that have a convoluted foam base with bolstered back and sides that are filled with fiberfill. If a pet punctures the material on the foam base or on the bolster of these prior art beds, the pet is likely able to pull out most of the filler and ruin the bed. For the pet couches, only the covers are typically washable so the inner materials continue to harbor dirt and odors. Furthermore, these pet couches are bulky and not easily transportable.

Several types of materials are used to make pet beds. Typical materials for covers include synthetic cloth, simulated sheepskin, or tough industrial fabrics. Unfortunately, these materials are not always comfortable for the pet and do not retain body heat well. Typical materials for filler include foam or fiberfill. The fiberfill used in some beds may tend to bunch together or may shift from under the pet when lying on the bed. In addition to these materials, some prior art pet beds have cedar chips mixed in with other filler material. Although the cedar chips may mask odors to a certain extent, use of the chips prevents owners from being able to wash portions of the pet bed because the cedar will absorb fluids and deteriorate. In addition, the cedar chips can produce cedar dust over time, and the dust can trigger allergies.

The subject matter of the present disclosure is directed to overcoming, or at least reducing the effects of, one or more of the problems set forth above

### SUMMARY OF THE DISCLOSURE

In one embodiment, an animal bed includes a tubular structure having a length and first and second sides. A filling material is positioned within the tubular structure. Portions of the first side substantially along the length of the tubular structure are attached to portions of the second side of the tubular structure such that the tubular structure forms a spiral pattern. In one embodiment, the spiral pattern is formed so that the bed is substantially flat. In another embodiment, the spiral pattern is formed so that the bed tends to define a concavity.

In another embodiment, an animal bed has a tubular structure substantially formed into a spiral pattern. Again, the spiral pattern can be formed so that the bed is substantially flat or can be formed so that the bed tends to define a concavity. A filling material is positioned within the tubular structure, and a plurality of baffles is positioned in the tubular structure to separate portions of filling material within the tubular structure.

The tubular structure can be made from a plurality of tubular members. Each tubular member has filling material and has a closed end and an open end. To form the tubular structure, the tubular members are attached closed end-to-open end. Once attached together, the closed ends of the tubular members form a plurality of baffles that separate portions of filling material within the tubular structure. Preferably, the tubular members are terried tube socks, and the filling material is a siliconized polyester fiberfill.

In yet another embodiment, a method of making an animal bed involves forming a substantially elongated tubular structure having a filling material. The tubular structure is formed into a spiral pattern by attaching outer sides of the tubular structure to inner sides of the tubular structure substantially along a length of the tubular structure. In one embodiment, the spiral pattern is formed so that the bed is substantially flat by attaching the outer sides of the tubular structure to the inner sides of the tubular structure substantially along the central axis of the tubular structure when forming the tubular structure into the spiral pattern. In alternative embodiment, the spiral pattern is formed so that the bed tends to define a concavity. To form the concavity, the spiral pattern is formed by attaching upper portions of the outer sides of the tubular structure to lower portions of the inner sides of the tubular structure when forming the tubular structure into the spiral pattern. In one embodiment, the tubular structure is formed by filling a plurality of tubular members with filling material. Each tubular member has an open end and a closed end. The tubular members are attached closed end-to-open end so that the closed ends of the tubular members form a plurality of baffles separating portions of filling material in the tubular structure.

The foregoing summary is not intended to summarize each potential embodiment or every aspect of the present disclosure.

### BRIEF DESCRIPTION OF THE DRAWINGS

The foregoing summary, preferred embodiments, and other aspects of subject matter of the present disclosure will be best understood with reference to a detailed description of specific embodiments, which follows, when read in conjunction with the accompanying drawings, in which:

FIG. 1 is a plan view of an embodiment of an animal bed.

FIG. 2 is a side view of the animal bed of FIG. 1.

FIG. 3 is a cross sectional view of a portion of the animal bed of FIG. 1.

FIG. 4A is a side view of a tubular member or tube sock.

FIG. 4B is a side view of tube socks attached together with one of the tube socks shown in cross section.

FIG. 4C is a side view of tube socks attached together to form an embodiment of a tubular structure for an animal bed according to the present disclosure.

FIGS. 5A through 5C are side views of additional embodiments of tubular structures for an animal bed according to the present disclosure.

While the subject matter of the present disclosure is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION

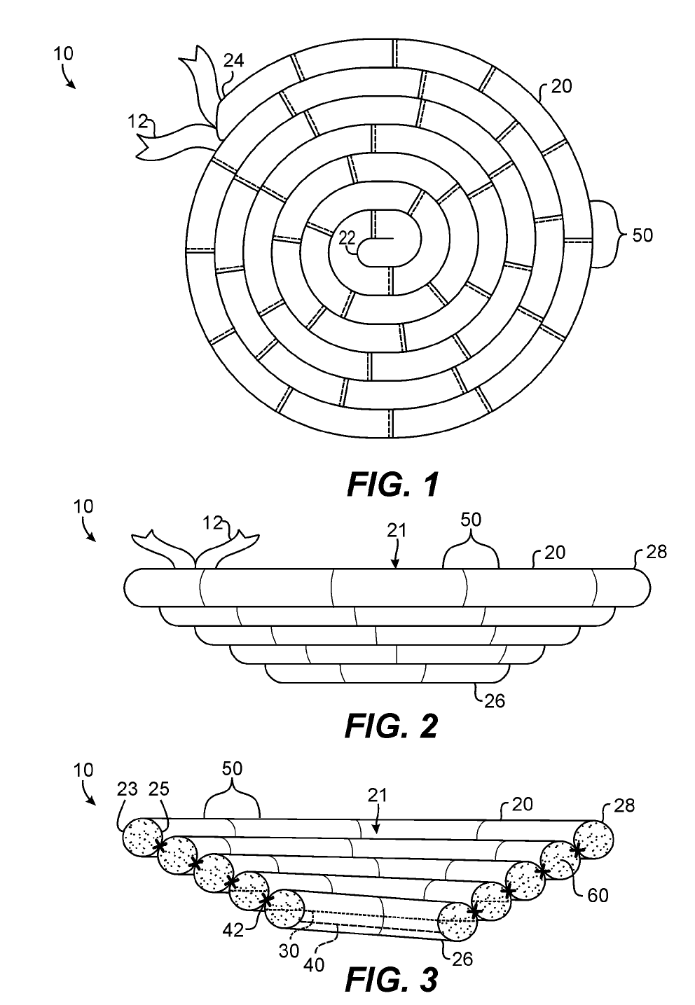

Referring to FIGS. 1 and 2, an embodiment of an animal or pet bed 10 according to the present disclosure is shown in a plan view and a side view, respectively. The pet bed 10 has a tubular structure 20 that is formed into a spiral pattern. In one embodiment, the spiral pattern is formed so that the bed 10 tends to be substantially flat. In another embodiment, the spiral pattern is formed so that the bed 10 tends to define a concavity 21, as best shown in FIG. 2. The concavity 21 formed in the pet bed 10 makes it comfortable for the pet and especially comfortable for a dog. When a dog lies in the bed 21, for example, outer portions 28 of the bed 10 tend to roll up around the dog to form a bowl.

The tubular structure 20 is made of a fabric material and is filled with a filling material (not shown). The fabric material is preferably a terried material or the like, which is soft, durable, and breathable. Terried material refers to fabric that has a complete terry on one side of the fabric. Such terried material is typically used for socks and can be made of cotton or other material. Sensura™ is a synthetic co-polymer of polyester and is a fabric material suitable for use in the bed 10. Sensura™ offers some advantages when compared to cotton. For example, Sensura™ is perceived to be more breathable and more comfortable than cotton. In addition, Sensura™ may tend to shrink less when laundered and may dry faster than cotton.

The filling material is preferably high-loft, siliconized polyester fiberfill, which is generally hypoallergenic, soft, resilient, and washable. The siliconization of the siliconized polyester fiberfill allows the material to shift and adjust to pressure, such as dog's weight, without substantially bunching or matting, which happens with plain fiberfill. The siliconized fibers tend to slide against one another without adhering or sticking to one another to the degree that occurs with a non-siliconized fiberfill.

In the present embodiment, the tubular structure 20 is formed from a plurality of tubular members 50, such as tube socks. The tube socks 50 are each filled with filling material and are joined end-to-end, as described in more detail below. The tube socks 50 are preferably terried from tip and toe, are made with a reinforced terried material or the like, and do not have a defined heel. Accordingly, the socks 50 are preferably colorfast, durable, and not subject to shrinking when washed so that the entire bed 10 can be washable, which is an advantage for the pet owner. In one embodiment, the tube socks 50 are about 24-inches long, are about12-inches in circumference, and allow for about -8 inches of cross stretch.

The pet bed 10 can be produced in various sizes suitable for different sized pets. For example, one size of the bed 10 can be about 30-inches in diameter, while another size can be about 50-inches in diameter. As shown in FIG. 1, a pair of ties 12 is attached to the bed's outside perimeter 28. The pet bed 10 can be rolled up or folded upon itself, and the pair of ties 12 can be tied around the folded bed 10 to keep it closed for storing and transporting.

Forming the spiral pattern of the bed 10 is best discussed with reference to FIG. 3, which shows a cross-section of a part of the pet bed 10. In FIG. 3, part of a central portion 26 of the bed 10 is not shown to reveal certain features. The tubular structure 20 generally has a central axis 30 and first and second sides 23 and 25. To form the spiral pattern, a first end (not shown) of the tubular structure 20 is bent and attached to itself. Then, portions of the first (outer) side 23 along the length of the tubular structure 20 are attached to portions of the structure's second (inner) side 25 as the tubular structure 20 is formed into the spiral pattern. The outer side 23 is generally that part of the tubular structure 20 that forms the outside perimeter of the spiral pattern, while the inner side 25 is generally that part of the tubular structure 20 that forms the inside perimeter of the spiral pattern. Preferably, sewing or stitching along the length of the tubular structure 20 is used to attach the first and second sides 23 and 25, but other techniques for attachment known in the art can be used.

In one embodiment, the spiral pattern is formed with the concavity 21. To form the concavity 21, upper portions of the outer side 23 of the structure 20 are sewn to lower portions of the inner side 25 of the structure 20, as the spiral pattern is sewn along the length of the structure 20. For example, stitching 42 is made substantially along a line 40 between portions of the outer side 23 above the plane of the central axis 30 to portions of the inner side 25 below the plane of the central axis 30. This tends to form the concavity 21 as the tubular structure 20 is sewn into the spiral pattern.

Even though the stitching 42 is preferably done uniformly along this line 40, which is offset from the central axis 30 of the tubular structure 20, the bed 10 is preferably reversible. For example, the concavity 21 can be formed on either side of the bed 10 by pushing or pulling the central portion 26 of the bed 10 relative to the outside edge 28 of the bed 10. Since the bed 10 is very pliable, it can be positioned on furniture, in a corner, or on the owner's bed for the pet to curl up in.

In another embodiment, the spiral pattern is formed to be substantially flat. To form the bed 10 to be substantially flat, stitching is made between the inner side 25 and the outer side 23 of the tubular structure 20 substantially along the central axis 30 of the tubular structure 20. This tends to form the spiral pattern as a substantially flat plane. Even though the spiral pattern is formed to be substantially flat, the bed 10 may still be manipulated to define a concavity by pulling the central portion 26 relative to the perimeter 28 because the structure of the bed 10 is generally malleable.

The pet bed 10 preferably reduces effects of shifting or bunching of the filling material when the bed 10 is used or washed. For example, the tube socks 50, as shown in FIGS. 1 and 2, each form an individual baffled chamber of filling material in the pet bed 10. These individual baffled chambers provide support across the entire body of a pet when lying in the bed 10. Since the fiberfill material is baffled within the tube socks 50, the fiberfill material is less likely to bunch together in the bed 10 or to shift when the pet lies on the bed 10 or when the bed 10 is washed.

In addition, the pet bed 10 preferably reduces the effects of odors. The fabric material of the tube socks 50 is preferably porous and breathes, allowing air to circulate through the bed 10. The entire bed 10 can be washed in a large capacity washer and dried in a dryer without substantially loosing its shape or loft, thereby directly addressing issues with odor.

Moreover, the pet bed 10 is preferably comfortable and durable. For example, the terried material of the tube socks 50 provides softness and warmth for a pet. Depending on the desired effect, the tube socks 50 can be used with the terried side exposed or with the smoother, woven side exposed. In addition, the material of the tube socks 50 is preferably heavy weight, durable, and not easily destroyed. As dog owners know, dogs tend to bite, scratch, or tear at their bedding. If a portion of the bed 10 is torn open, only the fiberfill material 60 in that baffled portion (i.e., one or more damaged tube socks 50) is accessible to the pet. The damaged tube sock 50 can be stuffed again and mended to repair the bed 10. Consequently, the baffled nature of the bed 10 keeps the filling material 60 intact in the individual tube socks 50. The filling material 60 contained in the individually baffled socks 50 will tend to adjust to a pet's bony prominences and provide support along the length of the pet's body.

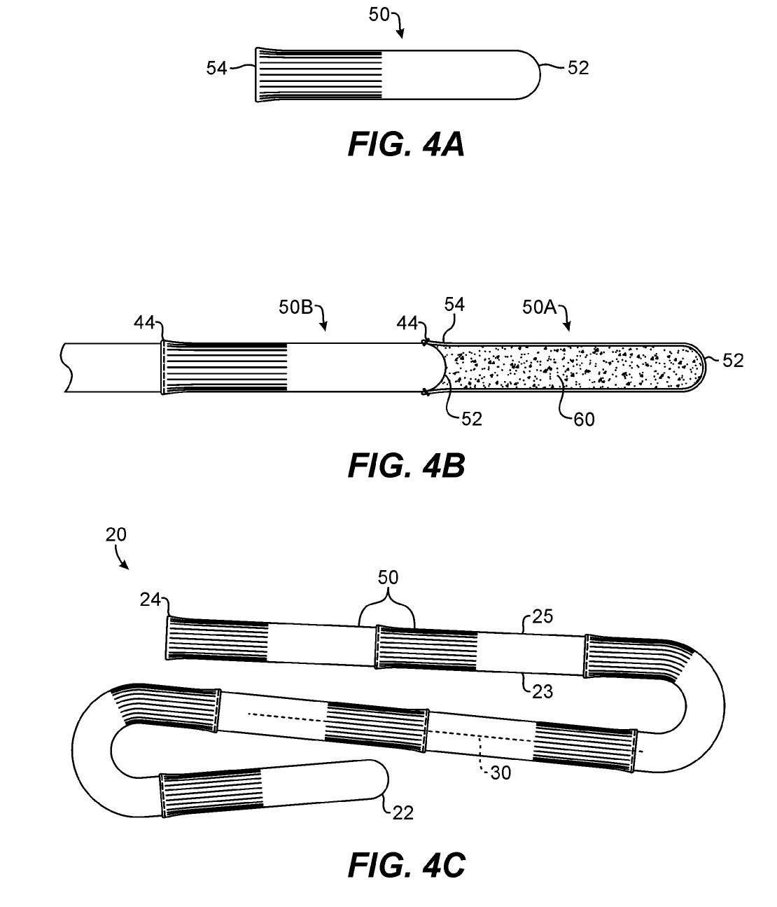

Steps for making the present embodiment of the pet bed 10 will now be discussed with references to FIGS. 4A through 4C. In FIG. 4A, a tubular member or tube sock 50 has a closed end 52 and an open end 54. The tube sock 50 is filled with filling material, such as high-loft, siliconized polyester fiberfill, using techniques known in the art. Once a number of tube socks 50 are filled, the tube socks 50 are sewn together end-to-end as described below.

As shown in FIG. 4B, one tube sock 50A is attached end-to-end to another tube sock 50B by partially positioning a portion of the closed end 52 of the one tube sock 50B into the open end 54 of another tube sock 50A. Then, portion of the open end 54 is stitched to the adjacent closed end 52. The stitching is schematically shown and is labeled with reference numeral 44. Preferably, the stitching 44 is performed around the entire circumference of the tube socks 50A and 50B. Once attached in this manner, the closed end 52 of the one tube sock 50B forms a barrier or baffle that separates the filling material 60 in the tube socks 50A, 50B.

Once a length of tube socks 50 have been joined in this manner, the resulting tubular structure 20 shown in FIG. 4C is formed. One end 22 is already closed because it is the closed end of one of the tube socks 50. The other end 24 can be closed by stitching the open end of the last tube sock 50 closed. Alternatively, the orientation of the last tube sock 50 can be reversed when attaching it at that end 24. The resulting tubular structure 20 is then formed into the spiral pattern. First, a portion at one end 22 of the structure 20 is bent upon itself and sewn together. Then, continuing along the length of the structure 20 substantially from the first end 22 to the second end 24, the first (outer) side 23 of the structure 20, which faces toward the perimeter of the spiral pattern, is attached to the second (inner) side 25, which faces towards the interior of the spiral pattern, in a manner consistent with the description above with reference to FIG. 3.

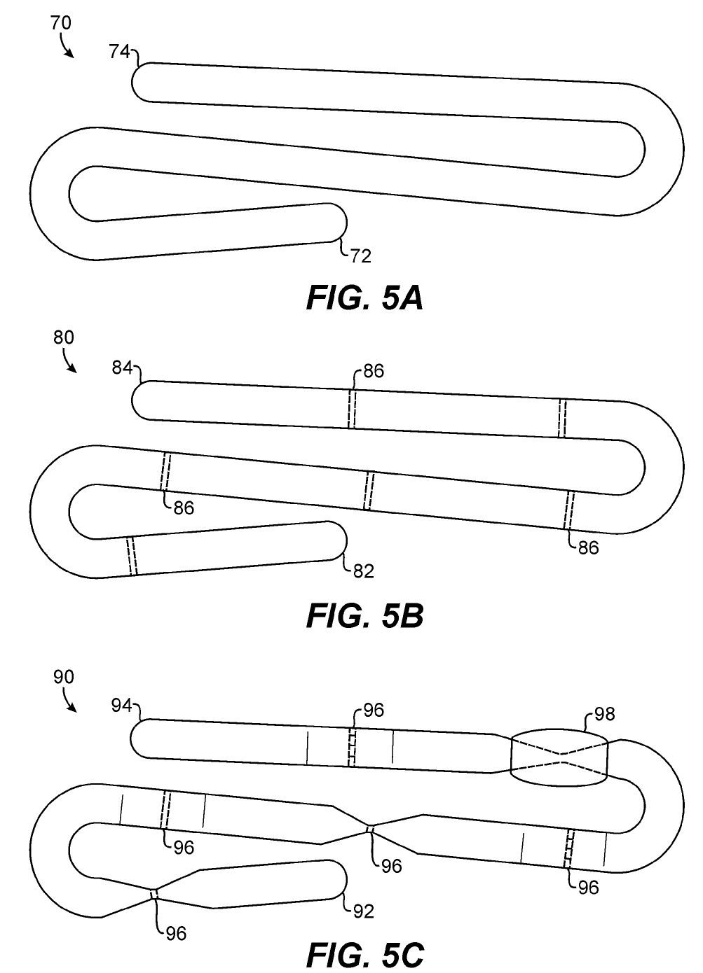

Referring to FIG. 5A, another embodiment of a tubular structure 70 is shown before being formed into the spiral pattern of a pet bed. In this embodiment, the tubular structure 70 is made from a substantially elongated tube of fabric material, such as terried material or the like. This elongated tube 70 is filled with filling material, and both ends 72 and 74 are sewn closed, for example. Once formed, this elongated tube 70 can be formed into the spiral pattern by the techniques discussed previously. The spiral pattern can be formed such that the bed tends to be flat or to define a concavity, as detailed above.

Referring to FIG. 5B, another embodiment of a tubular structure 80 is shown before being formed into the spiral pattern of a pet bed. In this embodiment, the tubular structure 80 again is made from a substantially elongated tube of fabric material, and both ends 82 and 84 are sewn closed after filling the tube 80 with filling material. However, in the present embodiment, baffles 86 have been positioned within the tubular structure 80 to separate portions of the filling material (not shown) from one another. These baffles 86 are inserted or formed at intervals in the long tube 80 while the tube 80 is being filled with filling material. Once the tube 80 has been filled, edges or ends of the baffles 86 can be sewn to the long tube 80 so that the baffles 86 are held substantially in place.

In one embodiment, these baffles 86 can be pieces, strips, or discs of fabric positioned in the tube 80. From the outside of the tube 80, the edges or ends of these baffles 86 can be sewn to the inside of the tube 80 to hold them in place. By positioning the baffles 86 inside of the tube 80, the overall uniform tubular shape of the elongated tube 80 when filled with material is not substantially disturbed. Yet, the baffles 86 provide the benefits of separating portions of the filling material noted previously.

Referring to FIG. 5C, yet another embodiment of a tubular structure 90 is shown before being formed into the spiral pattern of a pet bed. In this embodiment, the tubular structure 90 is again formed from an elongated tube of fabric material filled with filling material. In the present embodiment, the tubular structure 90 has baffles formed by a plurality of cinches 96 made transverse to the length of the tubular structure 90. These cinches 96 can be formed by sewing or stitching across the tubular structure 90 to close off or separate portions the filling material on the inside of the structure 90.

In one embodiment, the cinches 96 can be sewn in a uniform direction across the tubular structure 90. Alternatively and as shown in FIG. 5C, the cinches 96 can be sewn in altering directions across the tubular structure 90. Furthermore, closed loops 98 can be made about the cinches 96. These closed loops 98 can be formed by one or more tube socks filled with filling material and sewn end to end to form a donut shape around each cinch 96. These closed loops 98 may give more uniformity to the filling within the pet bed when formed into the spiral pattern discussed previously.

The foregoing description of preferred and other embodiments is not intended to limit or restrict the scope or applicability of the inventive concepts conceived of by the Applicant. In exchange for disclosing the inventive concepts contained herein, the Applicant desires all patent rights afforded by the appended claims. Therefore, it is intended that the appended claims include all modifications and alterations to the full extent that they come within the scope of the following claims or the equivalents thereof.

What is claimed is:

1. An animal bed, comprising:
a tubular structure having a length and first and second sides; and
a filling material positioned within the tubular structure,
wherein portions of the first side substantially along the length of the tubular structure are attached to portions of the second side of the tubular structure such that the tubular structure forms a spiral pattern.

2. The animal bed of claim 1, wherein the tubular structure comprises a plurality of tubular members, each tubular member having filling material therein and having a closed end and an open end, the tubular members attached closed end-to-open end to form the tubular structure.

3. The animal bed of claim 2, wherein the tubular members comprise tube socks.

4. The animal bed of claim 2, wherein the closed ends of the tubular members form a plurality of baffles separating portions of filling material within the tubular structure.

5. The animal bed of claim 1, wherein the tubular structure comprises a plurality of baffles positioned within the tubular structure and separating portions of filling material within the tubular structure.

6. The animal bed of claim 1, wherein the tubular structure comprises a plurality of cinches formed in the tubular structure and separating portions of filling material within the tubular structure.

7. The animal bed of claim 1, wherein a plurality of stitches made substantially along the length of the tubular structure attach the first side of the tubular structure to the second side of the tubular structure.

8. The animal bed of claim 1, wherein portions of the first side substantially along a central axis of the tubular structure are attached to portions of the second side substantially along the central axis such that the spiral pattern tends to be substantially flat.

9. The animal bed of claim 1, wherein portions of the first side above a central axis of the tubular structure are attached to portions of the second side below the central axis such that the spiral pattern tends to define a concavity.

10. The animal bed of claim 1, wherein the tubular structure comprises a terried material.

11. The animal bed of claim 1, wherein the filling material comprises siliconized polyester fiberfill.

12. The animal bed of claim 1, further comprising a pair of ties attached to an outside perimeter of the spiral pattern of the bed.

13. An animal bed, comprising:
a tubular structure formed into a spiral pattern;
a filling material positioned within the tubular structure; and
a plurality of baffles positioned in the tubular structure and separating portions of filling material within the tubular structure.

14. The animal bed of claim 13, wherein the tubular structure has a length and first and second sides, and wherein portions of the first side substantially along the length of the tubular structure are attached to portions of the second side of the tubular structure such that the tubular structure forms the spiral pattern.

15. The animal bed of claim 14, wherein a plurality of stitches made substantially along the length of the tubular structure attach the first side of the tubular structure to the second side of the tubular structure.

16. The animal bed of claim 13, wherein the tubular structure comprises a plurality of tubular members, each tubular member having filling material therein and having a closed end and an open end, the tubular members attached closed end-to-open end to form the tubular structure.

17. The animal bed of claim 16, wherein the tubular members comprise tube socks.

18. The animal bed of claim 16, wherein closed ends of the tubular members form the plurality of baffles separating portions of filling material within the tubular structure.

19. The animal bed of claim 13, wherein portions of the first side substantially along a central axis of the tubular structure are attached to portions of the second side substantially along the central axis such that the spiral pattern tends to be substantially flat.

20. The animal bed of claim 13, wherein portions of the first side above a central axis of the tubular structure are attached to portions of the second side below the central axis such that the spiral pattern tends to define a concavity.

21. The animal bed of claim 13, wherein the tubular structure comprises a terried material.

22. The animal bed of claim 13, wherein the filling material comprises siliconized polyester fiberfill.

23. The animal bed of claim 13, further comprising a pair of ties attached to an outside perimeter of the spiral pattern.

24. A method of making an animal bed, comprising the steps of:
forming a substantially elongated tubular structure having a filling material therein; and
forming the tubular structure into a spiral pattern by attaching outer sides of the tubular structure to inner sides of the tubular structure substantially along a length of the tubular structure.

25. The method of claim 24, wherein forming the tubular structure into the spiral pattern comprises—
forming the spiral pattern with a concavity by attaching upper portions of the outer sides of the tubular structure to lower portions of the inner sides of the tubular structure when forming the tubular structure into the spiral pattern.

26. The method of claim 24, wherein forming the substantially elongated tubular structure having the filling material therein comprises:
filling a plurality of tubular members with filling material, each tubular member having an open end and a closed end; and
attaching the tubular members closed end-to-open end,
wherein the closed ends of the tubular members form a plurality of baffles separating portions of filling material in the tubular structure.

27. The method of claim 26, wherein attaching the tubular members closed end-to-open end comprises:
positioning portions of the closed ends of tubular members partially into the open ends of other tubular members; and
stitching portions of the closed ends to the adjacent open ends.

28. The method of claim 26, wherein the tubular members comprise tube socks.

29. The method of claim 24, further comprising positioning a plurality of baffles within the tubular structure to separate portions of filling material within the tubular structure.

30. The method of claim 29, wherein positioning the plurality of baffles comprises making a plurality of cinches in the tubular structure.

31. The method of claim 24, wherein the tubular structure comprises a terried material.

32. The method of claim 24, wherein the filling material comprises siliconized polyester fiberfill.
